(19) United States
(12) Patent Application Publication
(10) Pub. No.: US 2010/0165316 A1
(43) Pub. Date: Jul. 1, 2010

(54) INCLINED EXPOSURE LITHOGRAPHY SYSTEM

(75) Inventors: YING-JUI HUANG, Taipei City (TW); Cheng-Hsuan Lin, Taoyuan County (TW); Fuh-Yu Chang, Hsinchu County (TW)

Correspondence Address: WPAT, PC;INTELLECTUAL PROPERTY ATTORNEYS, 7225 BEVERLY ST., ANNANDALE, VA, 22003, US

(73) Assignee: Industrial Technology Research Institute, Hsinchu (TW)

(21) Appl. No.: 12/721,183

(22) Filed: Mar. 10, 2010

(30) Foreign Application Priority Data
Dec. 24, 2007 (TW) 096149668
Jun. 20, 2008 (TW) 097122986

(51) Int. Cl. G03B 27/54

(52) U.S. Cl. 355/67

(57) ABSTRACT

An inclined exposure lithography system is disclosed, which comprises: a substrate; a photoresist layer, formed on the substrate; a mask, disposed over the photoresist layer with a gap therebetween; and a refraction element disposed over the mask so that a light beam from a light source is refracted by a specific angle.

### BACKGROUND OF THE INVENTION

1. Field of the Invention

The present invention generally relates to an inclined exposure lithography system and, more particularly, to an inclined exposure lithography system using a refraction element to change the direction of incident light, which is also diffracted, for inclined exposure lithography.

2. Description of the Prior Art

Photo-lithography is a key process in micro-electro-mechanical system (MEMS) processing and semiconductor processing. Conventional photo-lithography uses a light beam vertical to the mask and the photo-sensitive polymer to form planar (2-D) or high aspect-ratio (2.5-D) patterned structures and even achieve nano-scale precision.

To realize a 3-D patterned structure, photo-lithography is used with a specially designed mask (such as a gray-scale mask) to adjust the light intensity to expose and pattern the photo-sensitive polymer. Alternatively, the 2.5-D photo-sensitive polymer is performed with heat flow to be melt into a semi-sphere according to the surface tension. Alternatively, a special crystal surface is used to be anisotropically etched. Among them, the former two techniques result in uncontrollable surface roughness and inclined angle with high cost. The latter one results in only two inclined angles.

Conventional ultra-precision machining uses a diamond blade with specially designed inclined angle to cut the substrate to achieve micro-scale precision with controllable inclined angles. However, such top-down machining exhibits poor control over the substrate surface and the absolute height of the structure top. Moreover, problems result from surface treatment (such as electroless plating) on the surface, long machining time, residue contamination and cost for large-area machining.

Taiwan Patent No. 1278903 discloses a high aspect-ratio micro-structure and a method thereof. As shown in FIG. 1A to FIG. 1D, which are cross-sectional views showing the steps of a conventional inclined exposure lithography method. First, a transparent substrate 11 having a surface 111 is provided. Dark zones 112 and a lens 113 are formed on the surface 111. The lens 113 enables the light beam to focus after passing therethrough. Then, a photoresist layer 12 is formed on the surface 111. The light beam passes through the lens 113 to focus to remove part of the photoresist layer 12 to form an inclined structure having an inclined angle θ when the light source 13 illuminates the photoresist layer 12 through the transparent substrate 11. However, the inclined angle depends on the focus of the lens (such as the curvature radius), and therefore arc-shaped corners are formed due to non-uniform light intensity and light beam diffraction.

U.S. Pat. No. 7,012,762 discloses an immersion lithography module. In FIG. 2A, the substrate 21, whereon a photoresist layer 22 and a mask 23 are disposed, is immersed in a liquid medium 24 and is illuminated by a light beam 20. When the light beam 20 passes through the mask 23 to illuminate the photoresist layer 22, the photoresist layer 22 is inclinedly exposed to the light beam 20 and is as shown in FIG. 2B after lithography. Since the light intensity equals to the product of luminance and time and the luminance is in inverse proportion to distance squares, such inclined exposure results in poor-uniformity exposure, especially when the lithography area is larger. Therefore, this patent is limited by the inclined angle of the apparatus and is not suitable for processing on a large area. Moreover, the removal of the liquid medium from the substrate also causes problems.

Generally, for contact exposure (with no gap between the mask and the photoresist layer), if light from the light source is perpendicular to the substrate, the resulted pattern is as shown in FIG. 3A wherein the cross-sectional view shows that the angle of the etched portions is 90°. However, for proximity exposure (with a gap between the mask and the photoresist layer), optical diffraction leads to widened feature sizes and the resulted pattern is as shown in FIG. 3B. For example, when the mask and the photoresist layer are separated by 20 μm during exposure, the feature size is widened with a tilt of 15° as shown in FIG. 3C. As the gap between the mask and the photoresist layer increases from 20 μm to 40 μm, the feature size is further widened with a tilt of 22° as shown in FIG. 3D. Even worse, as shown in FIG. 3E and FIG. 3F, poor resolution of pattern transfer is exhibited. Therefore, the gap between the mask and the photoresist layer should be minimized.

When only a prism is used to change the direction of the light beam, refraction angle is limited to the refractivity of the material used for the prism. Generally, the refractivity is 1.5±0.2 to result in a refraction angle of about 30°. Therefore, it is very difficult to obtain a large refraction angle, which leads to a small inclined exposure angle, as shown in FIG. 3G. Some may incline the substrate to increase the inclined exposure angle. However, this causes non-uniform light intensity and results in only inclined patterns.

Moreover, when optical diffraction is considered, a small gap results in a small inclined angle (about 8°) that can only be used as a demolding angle for electroforming while a larger gap results in poor resolution of pattern transfer that can be used in non-planar applications.

Therefore, there is need in providing an inclined exposure lithography system characterized in that the angle is controllable and required equipments are existing and ready.

### SUMMARY OF THE INVENTION

It is an object of the present invention to provide to an inclined exposure lithography system using a refraction element disposed between a photoresist layer and a light source to change the direction of incident light, which is also diffracted, for inclined exposure lithography.

In order to achieve the foregoing object, the present invention provides an inclined exposure lithography system, comprising:

a substrate;

a photoresist layer formed on the substrate;

a mask, disposed over the photoresist layer with a gap therebetween; and

a refraction element disposed over the mask so that a light beam from a light source is refracted by a specific angle.

### BRIEF DESCRIPTION OF THE DRAWINGS

The objects, spirits and advantages of the preferred embodiments of the present invention will be readily understood by the accompanying drawings and detailed descriptions, wherein:

FIG. 1A to FIG. 1D are cross-sectional views showing the steps of a conventional inclined exposure lithography method;

FIG. 2A is a cross-sectional view showing another conventional inclined exposure lithography method;

FIG. 2B is a cross-sectional view showing an inclined structure formed by the inclined exposure lithography method in FIG. 2A;

FIG. 3A to FIG. 3G are SEM pictures showing inclined structures formed by a conventional inclined exposure lithography method;

FIG. 4A is a schematic diagram showing an inclined exposure lithography system according to one embodiment of the present invention;

FIG. 4B is a cross-sectional view showing an inclined structure formed by the inclined exposure lithography system in FIG. 4A;

FIG. 5A is a schematic diagram showing an inclined exposure lithography system according to another embodiment of the present invention;

FIG. 5B is a schematic diagram showing an inclined exposure lithography system according to still another embodiment of the present invention;

FIG. 5C is a schematic diagram showing an inclined exposure lithography system according to still another embodiment of the present invention;

FIG. 5D is a schematic diagram showing an inclined exposure lithography system according to still another embodiment of the present invention;

FIG. 6 is a schematic diagram showing a grating of an inclined exposure lithography system according to one embodiment of the present invention;

FIG. 7 is a schematic diagram showing an inclined exposure lithography system used with a light guide module according to one embodiment of the present invention; and

FIG. 8A to FIG. 8F are SEM pictures showing inclined structures formed by an inclined exposure lithography system according to one embodiment of the present invention.

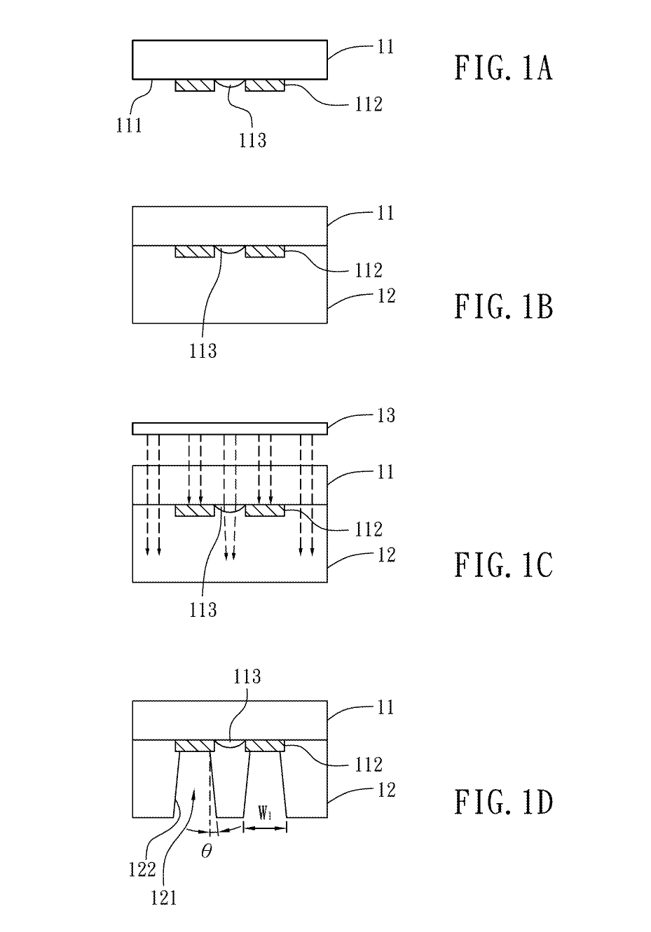

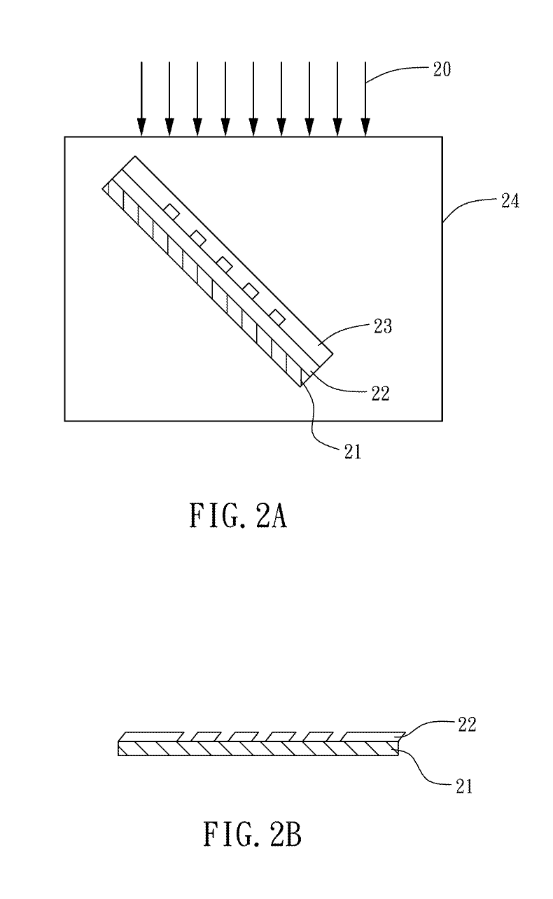

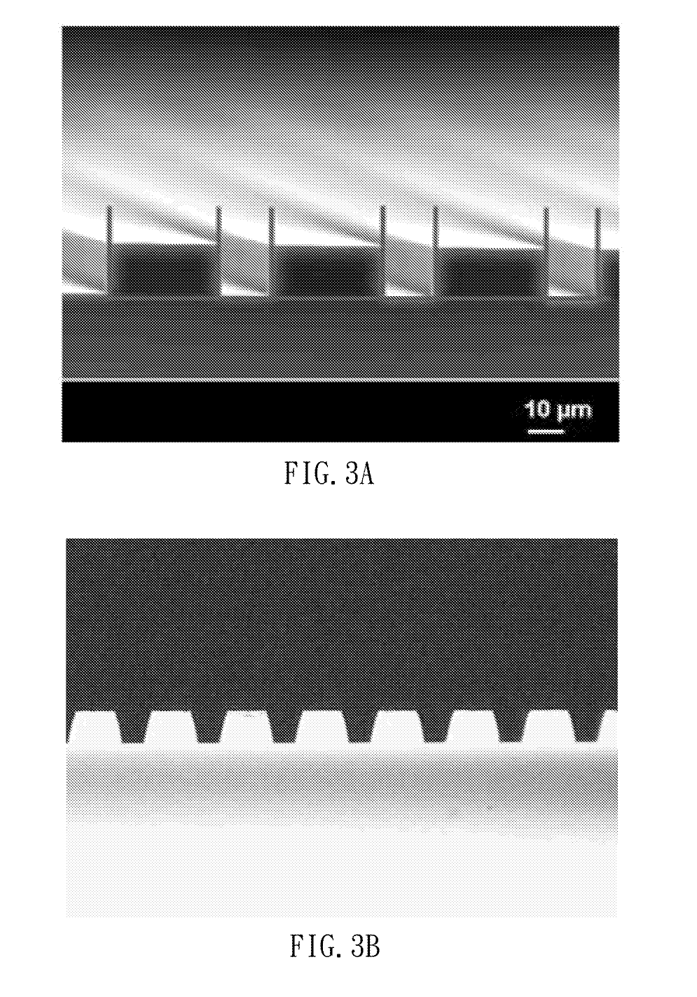

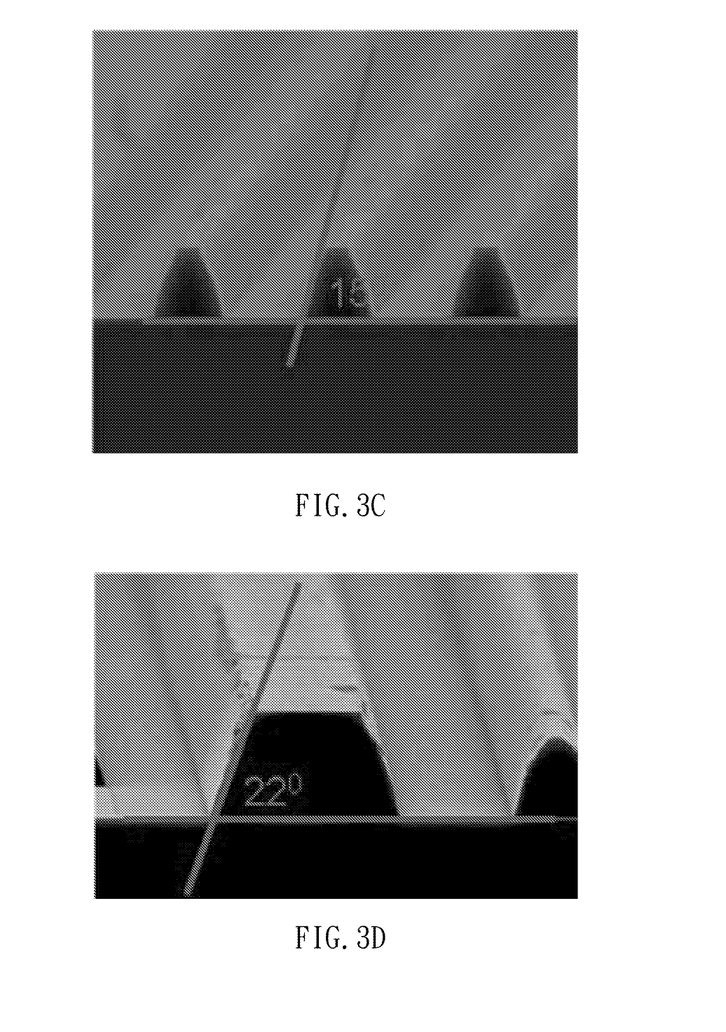

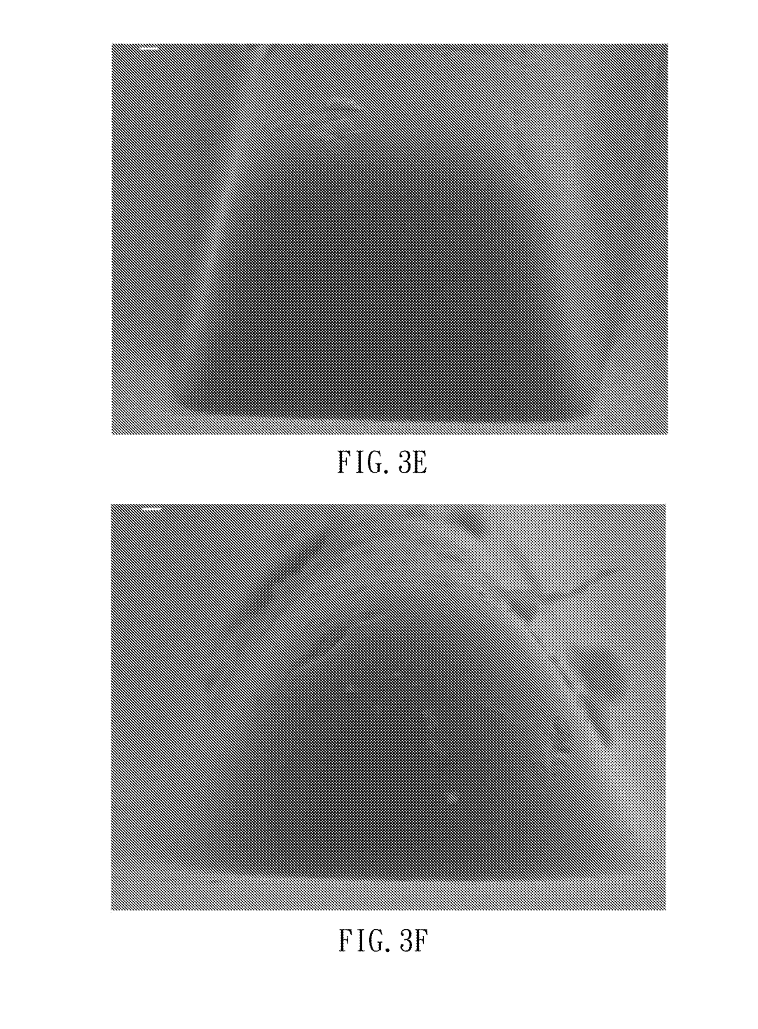

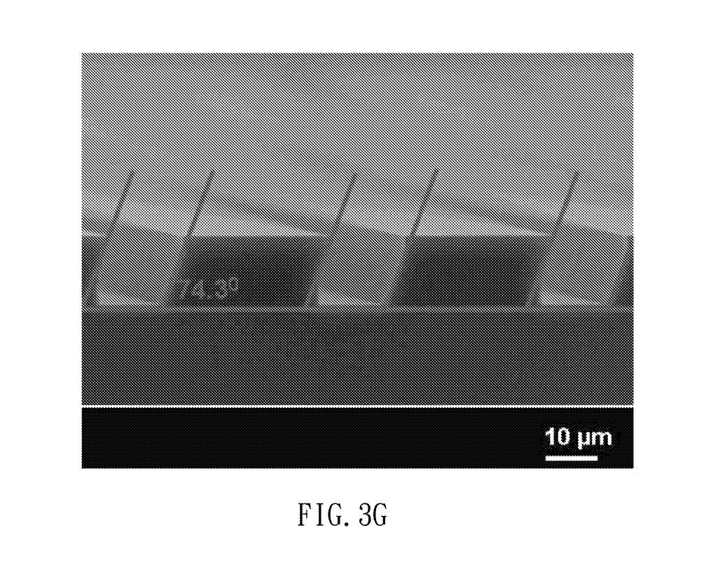

### DETAILED DESCRIPTION OF THE PREFERRED EMBODIMENT

The present invention can be exemplified but not limited by the preferred embodiments as described hereinafter.

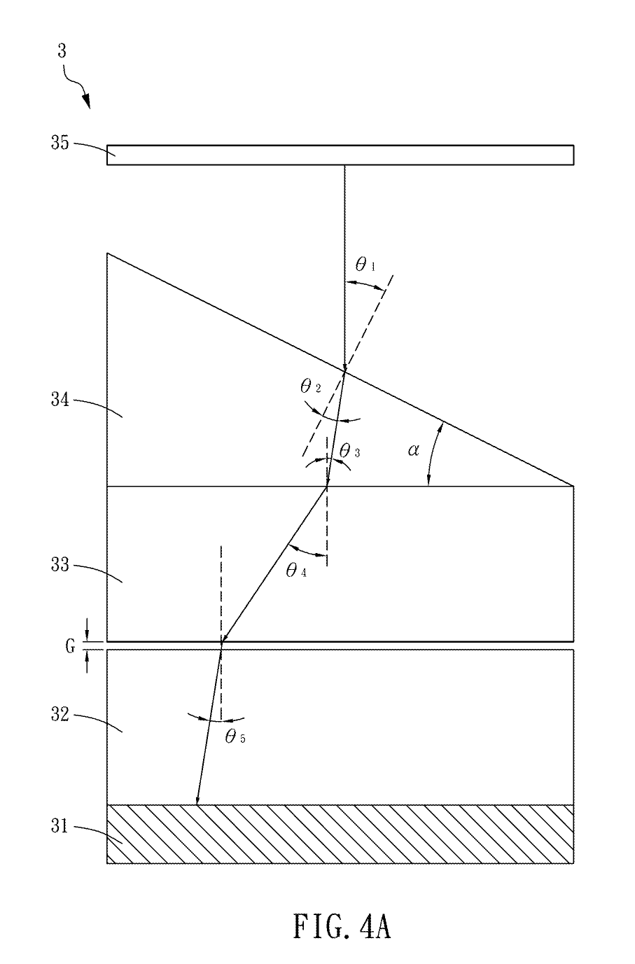

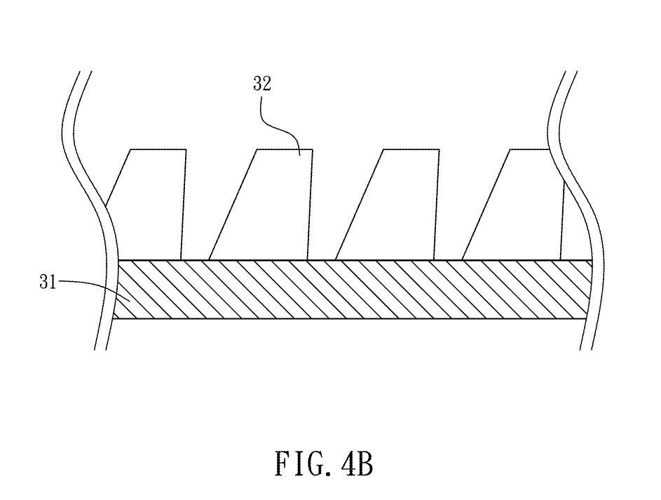

FIG. 4A is a schematic diagram showing an inclined exposure lithography system according to one embodiment of the present invention;

Referring to FIG. 4A, the inclined exposure lithography system 3 comprises a substrate 31, a photoresist layer 32, a mask 33, a refraction element 34 and a light source 35. The photoresist layer 32 is coated on the substrate 31. The substrate 31 can be a silicon substrate, a glass substrate or an acrylic substrate. After the photoresist layer 32 is coated on the substrate 31, it is cured by soft-baking. Then, the mask 33 having a pre-designed pattern thereon is disposed over the photoresist layer 32 to perform pattern transfer by exposing the photoresist layer 32 to a light source 35 (for example, an ultra-violet (UV) light source). The photoresist layer 32 can be a positive photoresist layer or a negative photoresist layer.

Compared to the prior art, in the present invention, a refraction element 34 is disposed between the mask 33 and the light source 35 to change the direction of the light beam from the light source 35. Meanwhile, a gap is formed between the mask 33 and the photoresist layer 32. In FIG. 4A, the refraction element 34 is a prism. According to Snell's Law, the emergent angle θ₅ of the light beam can be controlled as long as the incident angle θ₁ of the light beam and the inclined angle α of the refraction element 34 are adjusted when the materials for the refraction element 34 and photoresist layer 32 are selected to determine the refractivities. Meanwhile, the gap G is determined to control diffraction.

If the photoresist layer 32 is a positive photoresist layer. The exposed photoresist (unshielded by the mask 33) will be removed so as to obtain a transferred pattern. On the contrary, if the photoresist layer 32 is a negative photoresist layer. The exposed photoresist (unshielded by the mask 33) will be strengthened by cross-linking so that the unexposed photoresist will be removed to form a transferred pattern.

As shown in FIG. 4B, after lithography, an inclinedly exposed photoresist layer 32 is formed on the substrate 31 and is then hard-baked, exposed and developed, etched and removed to form a patterned structure. The patterned structure is coated with a seed layer by sputtering. Then, electro-plating and demolding are performed to obtain a mold insert, which is later used to wrap around a roller to roll on an optical substrate. However, the aforesaid processing is well known to those in the art, and thus description thereof is not presented here.

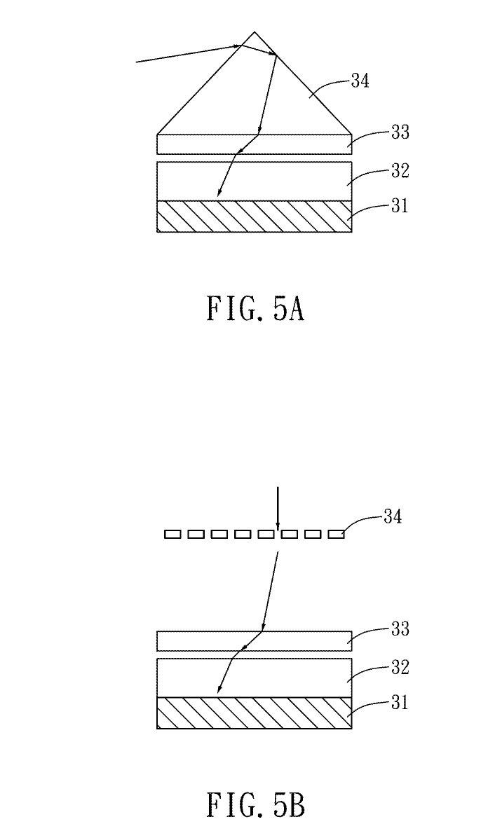

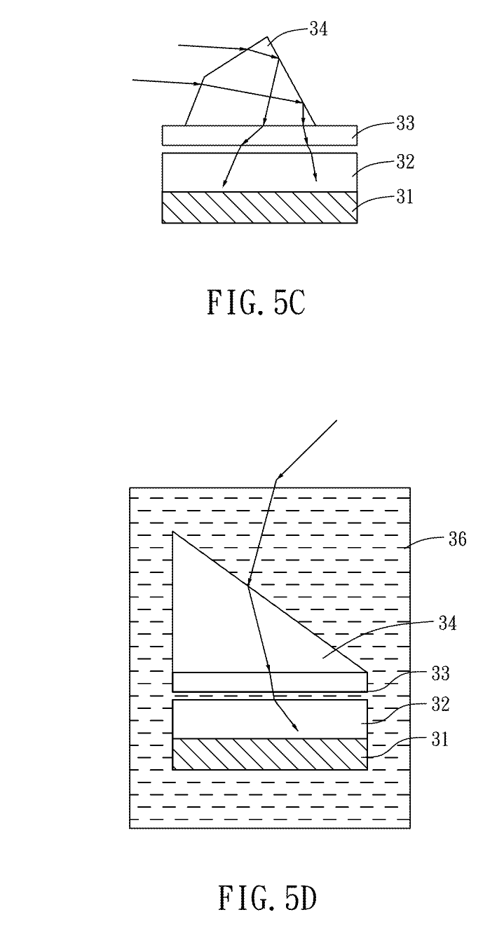

In the present invention, the refraction element 34 can also be a triangular prism (as shown in FIG. 5A) or a micro-structure grating (as shown in FIG. 5B). The prism can also be a polygonal prism (as shown in FIG. 5C). The refraction element can be selected from the aforesaid examples according to the user's requirement as long as it is capable of changing the direction of the light beam for inclined exposure lithography.

Moreover, the refraction element can be coated with at least a transparent medium so as to change the angle of the incident light. Alternatively, the substrate 31, the photoresist layer 32, the mask 33 and the refraction element 34 are immersed in a liquid 36 having a different refractivity from that of the refraction element 34 to further adjust the direction of the incident light, as shown in FIG. 5D.

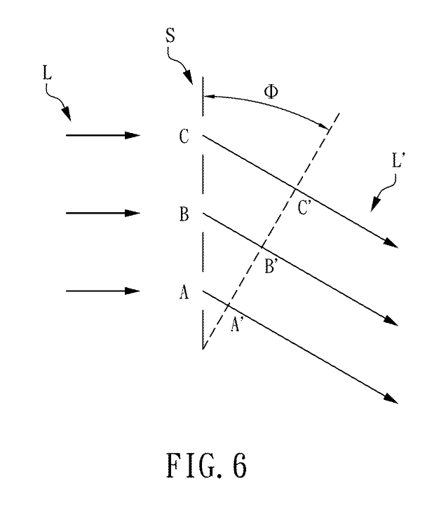

Please further refer to FIG. 6, which is a schematic diagram showing a grating of an inclined exposure lithography system according to one embodiment of the present invention. In FIG. 6, only three slits are shown. However, the present invention is not limited thereto. When monochromatic planar light L is incident on the grating S, the optical path difference of the secondary sub-wave L′ from the first slit, the second slit and the third slit is AA′=λ, BB′=2λ, CC′=3λ, respectively, wherein, λ is a monochromatic wavelength. Therefore, the grating S changes the direction of the monochromatic light and achieves the same function as a prism.

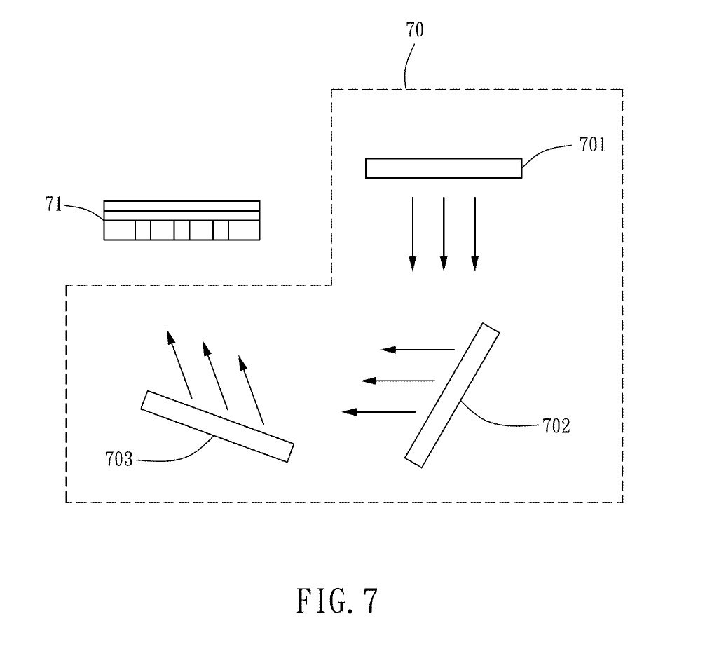

FIG. 7 is a schematic diagram showing an inclined exposure lithography system used with a light guide module according to one embodiment of the present invention. In FIG. 7, the light guide module 70 is used as a light source, which comprises an illuminant portion 701, reflectors 702 and 703 and an inclined exposure lithography system 71. The illuminant portion 701 is capable of generating parallel light. The reflector 702 is a 45° mirror-like surface, which is capable of reflects the parallel light. The reflector 703 is a non 45° mirror-like surface, which is capable of reflects the reflect parallel light further into the inclined exposure lithography system 71 for lithography.

In the present invention, in addition to using a prism, the light beam is also diffracted before the photoresist layer is exposed. A 5˜150 μm gap is formed between the mask and the photoresist layer so that the pattern of the exposed photoresist layer is trapezoid instead of rectangular. Moreover, the prism enables the light beam to perform incline exposure lithography to not only increase the inclined angle but also manufacture a micro-structure trapezoid pattern, which is very suitable for applications in optical films such as light guide plates.

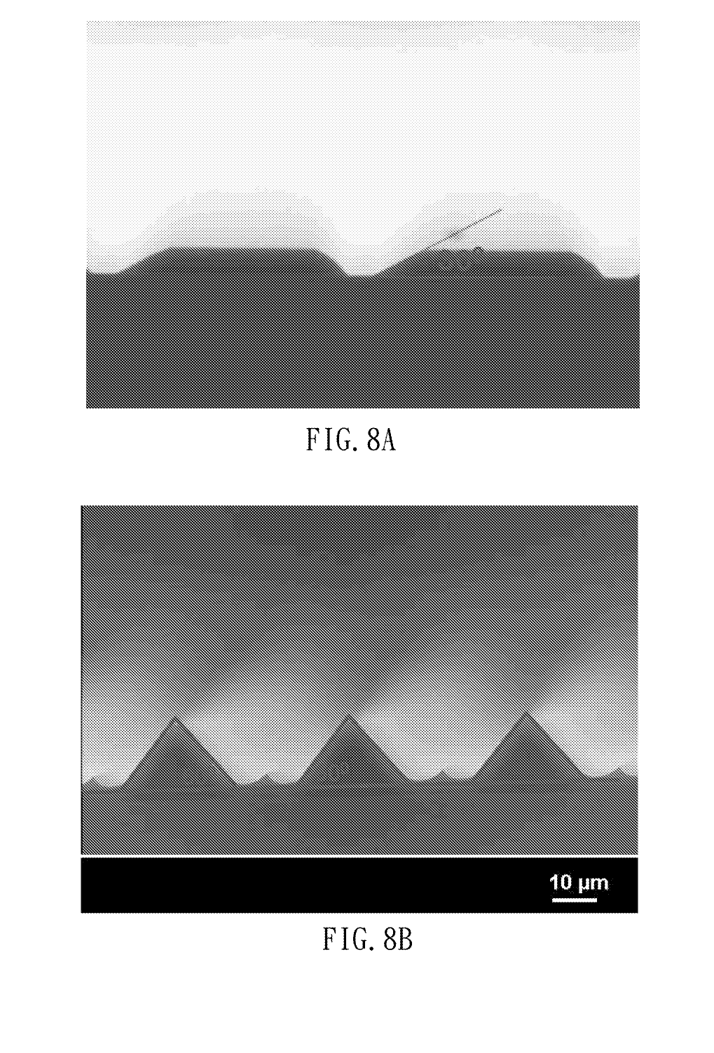

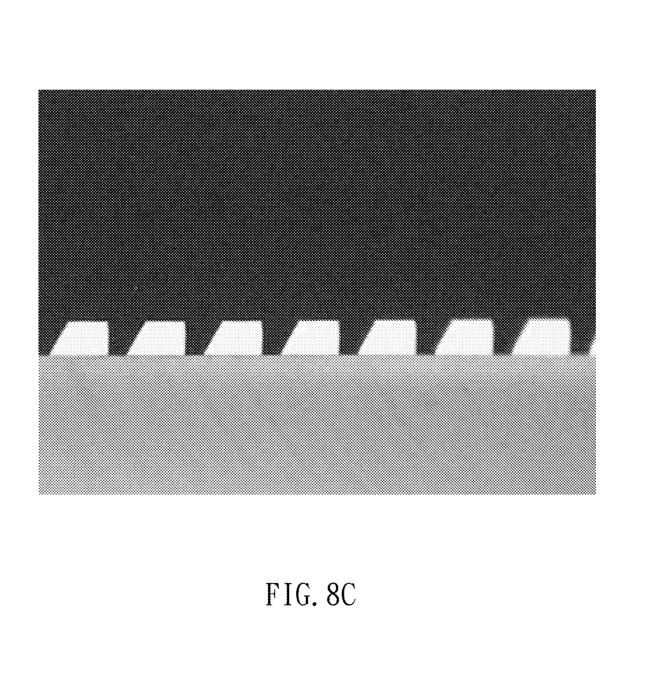

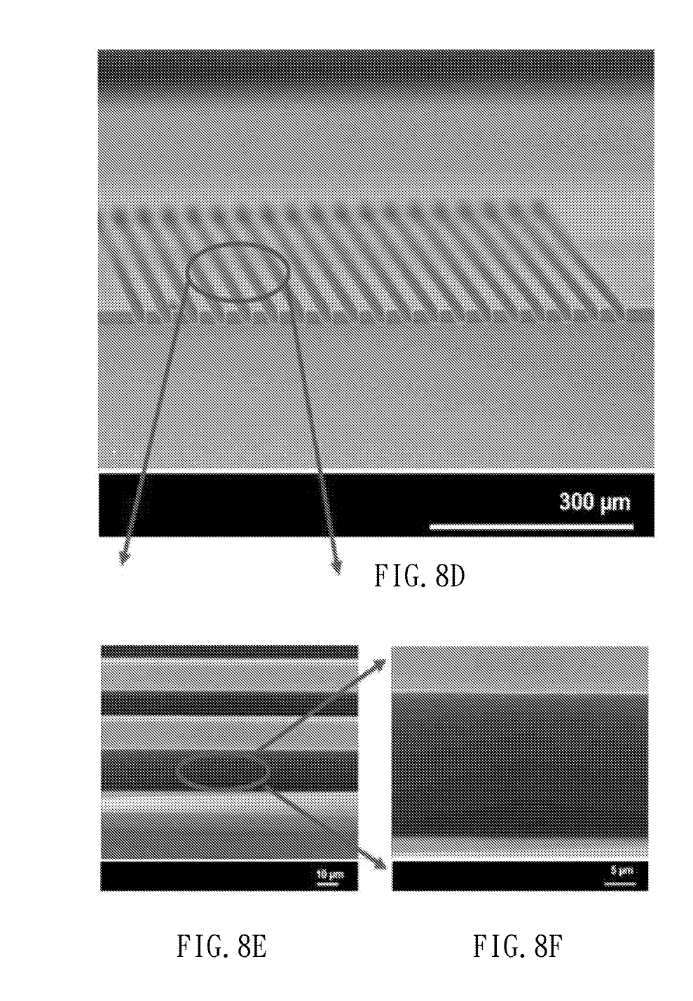

FIG. 8A to FIG. 8F are SEM pictures showing inclined structures formed by an inclined exposure lithography system according to one embodiment of the present invention. FIG. 8A shows a SEM picture of a large-angle pattern formed by lithography and diffraction using an inclined exposure lithography system of the present invention. FIG. 8B shows a SEM picture of a V-cut pattern formed by two-step lithography and diffraction using an inclined exposure lithography system of the present invention. FIG. 8C shows a SEM picture of a trapezoid pattern formed by lithography and diffraction using an inclined exposure lithography system of the present invention. Such a trapezoid pattern with an inclined angle over 60° is very suitable for applications in optical films such as light guide plates.

FIG. 8D is a 3-D SEM picture of the trapezoid pattern in FIG. 8C. From FIG. 8D, it is observed that the pattern exhibits high planarity. FIG. 8E is a top view of the pattern in FIG. 8D. FIG. 8F is an enlarged view of FIG. 8E. From FIG. 8E and FIG. 8F, it is observed that the pattern exhibits high planarity and high resolution.

Therefore, the refraction element of the present invention is disposed to change the incident angle and the emergent angle by an angle larger than 0° and smaller than 180° so that an inclined pattern can be formed by performing inclined exposure lithography on the photoresist layer. Generally, the inclined angle of the currently used optical film is larger than 60°. Unless precision machining is used, it is hard to manufacture a large-area and large-angle inclined surface with any lithographical process. However, in the present invention, a prism is used with inclined exposure to manufacture a large-area and large-angle inclined surface and overcome the issues such as exposure uniformity, surface roughness and arc-shaped corners as in the prior art.

Accordingly, the inclined exposure lithography system is capable of manufacturing a large-area substrate to exhibit high throughput. Moreover, the inclined angle depends on the refractivity of the refraction element and how the refraction element is disposed, which results in diverse exposure examples using simplified processing by equipments existing and ready. Moreover, not only vertical patterns can be formed by lithography. V-cut, trapezoid and rectangular patterns can be formed by adjusting the exposure angle to advance from 2-D to 3-D structure. Moreover, by the use of a prism and diffraction to perform lithography, a large-area substrate can be manufactured with high uniformity and high resolution as long as the material of the prism is selected without inclining the substrate. Moreover, a micro-structure trapezoid pattern can be formed, which is very suitable for applications in optical films such as light guide plates.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An inclined exposure lithography system for forming an optical film, the inclined exposure lithography system comprising:
a substrate;
a photoresist layer formed on the substrate;
a mask, disposed over the photoresist layer with a gap therebetween; and
a refraction element disposed over the mask so that a light beam from a light source is refracted by a specific angle.

2. The inclined exposure lithography system as recited in claim 1, wherein the refraction element is a prism.

3. The inclined exposure lithography system as recited in claim 2, wherein the prism is a polygonal prism.

4. The inclined exposure lithography system as recited in claim 2, wherein the prism is coated with a transparent medium thereon.

5. The inclined exposure lithography system as recited in claim 1, wherein the gap is larger than 5 μm and smaller than 150 μm.

6. The inclined exposure lithography system as recited in claim 1, wherein the light source comprises a light guide module.

7. The inclined exposure lithography system as recited in claim 1, wherein the refraction element is a triangular prism.

8. The inclined exposure lithography system as recited in claim 1, wherein the refraction element is a micro-structure grating.

9. The inclined exposure lithography system as recited in claim 8, wherein the optical path difference of the light beam passing through slits of the micro-structure grating is integer times of the wavelength of the light beam.

10. The inclined exposure lithography system as recited in claim 1, wherein the substrate is a silicon substrate, a glass substrate or an acrylic substrate.

11. The inclined exposure lithography system as recited in claim 1, wherein the light source is an ultra-violet (UV) light source.

12. The inclined exposure lithography system as recited in claim 1, wherein the photoresist layer is a positive photoresist layer or a negative photoresist layer.

13. The inclined exposure lithography system as recited in claim 1, wherein the refraction element comprises a material selected from a group consisting of glass, quartz, plastic and polymer.

14. The inclined exposure lithography system as recited in claim 1, wherein the specific angle is larger than 0 degree and smaller than 180 degrees.

15. The inclined exposure lithography system as recited in claim 1, wherein the substrate, the photoresist layer, the mask and the refraction element is immersed in a liquid, wherein the refraction index of the refraction element is different from that of the liquid.
